(19) United States
(12) Patent Application Publication
(10) Pub. No.: US 2025/0224993 A1
(43) Pub. Date: Jul. 10, 2025

(54) Methods For Building And Integrating A Machine Learning-Based Predictor To Provision The CPU Resource For Cloud Databases

(71) Applicant: Oracle International Corporation, Redwood Shores, CA (US)

(72) Inventors: Onur Kocberber, Thalwil (CH); Tikhon Parshikov, Lausanne (CH); Marc Jolles, Zurich (CH); Seema Sundara, Nashua, NH (US); Nipun Agarwal, Saratoga, CA (US)

(21) Appl. No.: 18/405,296

(22) Filed: Jan. 5, 2024

(51) Int. Cl. G06F 9/50; G06F 16/21; G06N 5/01

(52) U.S. Cl. CPC G06F 9/505; G06F 16/217; G06N 5/01

(57) ABSTRACT

Techniques are provided for optimizing resources (e.g., CPU, memory, IO) allocated to a database server using one or more machine learning models. A database management system executes a database workload for the database server. During execution of the workload, a monitoring service collects metrics for the database workload and sends the metrics to a resource allocation prediction service. The resource allocation prediction service implements one or more machine learning models to generate optimized resource allocation predictions. A generated resource allocation prediction is sent to a change recommendation generation service that generates change instructions for updating the resources allocated to the database server in order to align the current resource allocation of the database server with the resource allocation prediction.

### FIELD OF THE INVENTION

The present invention relates to database system configuration and, more specifically, to automatically generating allocations of resources for one or more database servers based on a given database workload.

### BACKGROUND

Modern database systems may use one or more compute instances to execute one or more database instances. Some of the tasks associated with deploying the one or more database instances on one or more compute instances include provisioning server resources such as central processing unit (CPU) resources, memory resources, and any other resource that may be provisioned to a database server. CPU resources are one of the most critical hardware resources provisioned to a database server as CPU resources process all requests and associated operations. However, provisioning the optimal number of CPU resources may be challenging. If CPU resources are under-provisioned, then processing bottlenecks may occur leading to slow processing performance. However, if CPU resources are over-provisioned, that is too many CPU cores are provisioned to a database server, then the CPU resources may sit idle as there may not be enough workload for the number of CPU resources provisioned.

Conventional solutions rely on database administrators to manually provision resources based on their past experiences. For example, database administrators may initially rely upon standard resource allocation templates that provision resources based on a generic size and shape of the database. Database administrators may also base resource allocations on specific system metrics such as latency, throughput, memory utilization, and buffer pool hit rate, while ensuring that the CPUs are not overutilized. If the initial resource allocation does not meet performance optimization goals, then database administrators may modify resource allocations using a trial-and-error approach. The trial-and-error approach generally results in having to add or remove hardware allocations until performance optimization goals are met. Unfortunately, the trial-and-error approach may also result in several iterations of changing resource allocations until a preferred resource allocation is achieved. Thus, a more systematic approach to predicting optimal resource allocations for database servers is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a database management system, according to an embodiment.

FIG. 2 depicts an example decision tree for predicting CPU resource changes, according to an embodiment.

FIG. 3 is a block diagram that depicts logic for generating change recommendation instructions using resource predictions from multiple machine learning models, according to an embodiment.

FIG. 4 depicts a flowchart for automatically generating change recommendation instructions for modifying hardware resources for one or more database servers, according to an embodiment.

FIG. 5 depicts a computer system that may be used in an embodiment.

FIG. 6 depicts a software system that may be used in an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Embodiments implement a prediction-driven approach to optimizing resources allocated to a database server instance based on metrics collected during execution of a workload. The prediction-driven approach implements one or more machine learning models to determine the optimal resource allocation size for allocated resources based on a given workload.

In an embodiment, a CPU machine learning model may be implemented to generate a prediction of an optimized number of CPU resources for a database server instance executing on a virtual machine. The CPU machine learning model may be implemented to receive, as input, metrics collected from executing a workload on the database server instance. The CPU machine learning model may also receive, as input, the current cloud shape for the database server instance and information about the workload executed on the database server instance. A cloud shape represents a configuration of allocated resources for the database server instance. For example, the cloud shape may define the number of CPU resources to be allocated and the amount of memory to be allocated to the database server instance. CPU resources may refer to a number of CPUs or a number of CPU cores allocated to the database server instance. For instance, if a virtual machine running a database server instance is hosted on a node that is equipped with single-core processors, then the CPU resources may refer to single-core CPU processors. If, however, the virtual machine running the database server instance is hosted on a node that is equipped with multicore processors, then the CPU resources may refer to CPU cores.

In an embodiment, a database management system executes a database workload for a database server instance. During execution of the workload, a monitoring service collects metrics for the database workload, where the metrics may include CPU metrics for one or more CPUs allocated to the particular database. The collected metrics are then sent to a resource allocation prediction service to generate a resource allocation prediction. The resource allocation prediction represents an optimized allocation of resources for the given shape of the database server instance and the executed workload. The resource allocation prediction service implements the CPU machine learning model and sends, as input to the CPU machine learning model, the received metrics. The metrics may include CPU metrics such as CPU idle time, CPU wait time for input/output, number of processes waiting for runtime, number of processes in uninterruptible sleep, and so on. A change recommendation generation service receives the resource allocation prediction, from the CPU machine learning model, and generates change recommendation instructions that include change instructions for updating the resources allocated to the database server instance to align the current resource allocation of the database server instance with the resource allocation prediction.

Additional machine learning models may be implemented to provide resource allocation predictions for other types of resources allocated to the database server instance. For example, a memory machine learning model may be implemented, along with the CPU machine learning model, to provide optimized resource allocation predictions for the database server instance. In an embodiment, the resource allocation prediction service may implement both the CPU machine learning model as well as the memory machine learning model. When multiple machine learning models are implemented, the monitoring service may collect metrics relevant to each of the machine learning models implemented. For example, if both the CPU machine learning model and the memory machine learning model are implemented, then the monitoring service may collect CPU-based metrics and memory-based metrics. Both types of metrics may be sent to the resource allocation prediction service, which may send the CPU metrics, as input, to the CPU machine learning model and send the memory metrics, as input, to the memory machine learning model. The CPU machine learning model then generates a CPU resource allocation prediction, and the memory machine learning model generates a memory resource allocation prediction.

In an embodiment, the change recommendation generation service may receive predictions from each of the machine learning models implemented. For instance, the change recommendation generation service may receive a CPU resource allocation prediction and a memory resource allocation prediction. The change recommendation generation service may implement heuristics to evaluate the received resource allocation predictions to ensure that one resource allocation prediction does not unintentionally cause a bottleneck on another resource allocation. For example, if the CPU resource allocation prediction indicates that the CPU resources for the database server instance should be increased but the memory resource allocation prediction indicates that the allocated memory should be reduced, then the effect of reducing the memory and increasing the number of CPU resources may result in idle CPU resources because of the lack of sufficient memory allocated compared to the available CPU resources allocated. Thus, the change recommendation generation service implements heuristics that ensure predictions for multiple resources are not conflicting. Using the previous example, the heuristics implemented by the change recommendation generation service may generate change recommendation instructions that include increasing the CPU resources and increasing the memory resources even though the memory resource allocation prediction indicates that the allocated memory should be reduced.

By implementing a system that uses machine learning models to evaluate metrics for executed workloads, resource allocations for database server instances may be optimized for optimal database performance. Optimizing the deployment of resource allocations would reduce the need for a manual trial-and-error approach, thereby reducing the amount of processing resources needed to iteratively update resource allocation configurations for database server instances. Additionally, optimizing resource allocations for database server instances may conserve computing resources that may otherwise be over-allocated to database server instances.

### Structural Overview

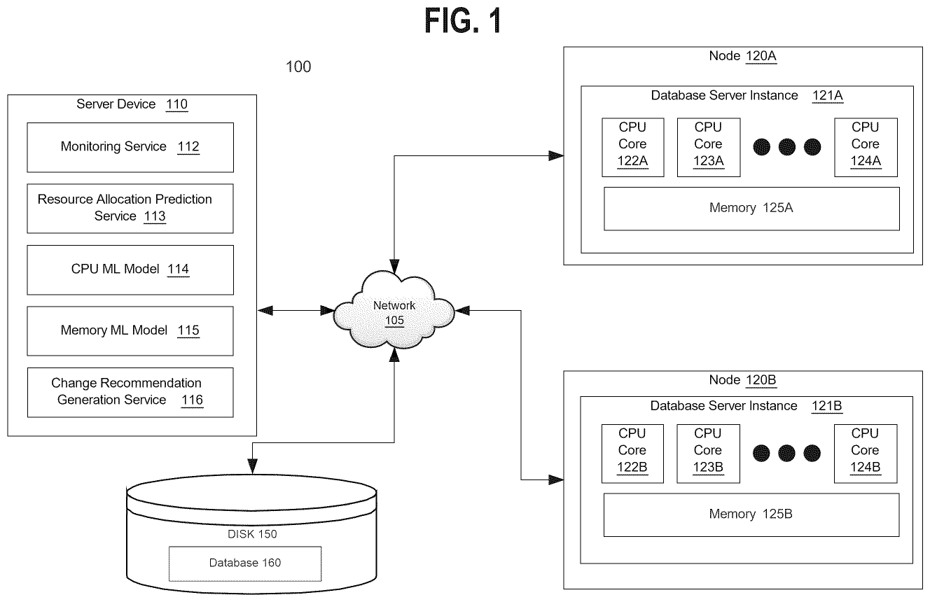

FIG. 1 is a block diagram that depicts a database management system (DBMS), according to an embodiment. DBMS 100 includes nodes 120A, 120B, disk 150, and server device 110 communicatively connected via network 105. Although two nodes are depicted in the present illustration, in other embodiments, DBMS 100 may comprise fewer or more nodes. Network 105 may be any type of network that provides communications, exchanges information, and/or facilitates the exchange of data between components of DBMS 100. For instance, network 105 may represent one or more local area networks (LANs), wide area networks (WANs), metropolitan area networks (MANs), or any other network implemented to facilitate data exchange between the components of DBMS 100.

Each of nodes 120A and 120B have access to database 160. For the purposes of illustration, database 160 is shown as stored on a single shared disk 150, but in alternative embodiments database 160 may be spread across multiple disks to which each of nodes 120A and 120B have access.

In an embodiment, each of nodes 120A and 120B includes one or more multicore processors connected to main volatile memory via a bus. Nodes 120A and 120B each represent a server device implemented to run a database server instance. Database server instances 121A and 121B represent server instances of a database running in DBMS 100. While in the illustrated embodiment each node is executing a single database server instance, in alternative embodiments, a single node may execute more than one database server instance.

In an embodiment, database server instances 121A and 121B may be running within dedicated virtual machines running on nodes 120A and 120B, respectively. FIG. 1 depicts database server instance 121A as having CPU cores 122A, 123A, 124A, and memory 125A allocated. Database server instance 121B is depicted with CPU cores 122B, 123B, 124B, and memory 125B allocated. Each of CPU cores 122A, 123A, 124A, 122B, 123B, and 124B are connected to their respective local cache. In an embodiment, the local cache may comprise an L1 or L2 cache, or a scratchpad memory. Scratchpad memory may refer to a fast-access memory that is electronically coupled to a coprocessor or a subset of one or more CPU cores on a CPU.

In an embodiment, server device 110 represents a computing device, such as a server computer, implemented to execute monitoring service 112 and resource allocation prediction service 113. Monitoring service 112 represents a computer process or program configured to monitor and collect performance metrics when performing database operations associated with database server instance 121A and database server instance 121B. For example, DBMS 100 may execute a sample workload that includes a variety of workload conditions on a variety of datasets. Monitoring service 112 may then collect various metrics related to CPU performance, memory performance, and any other hardware performance metric observed. For example, monitoring service 112 may collect metrics during execution of the workload from database server instance 121A and database server instance 121B. The metrics may include metrics for CPU usage, disk usage, memory usage and any other observed metrics associated with hardware components. For instance, CPU usage metrics include, but are not limited to, CPU idle time, CPU wait time for input/output, number of processes waiting for runtime, number of processes in uninterruptible sleep, number of interrupts per second, number of context switches per second, time spent running non-kernel code, time spent running kernel code, and time stolen from a virtual machine. Examples of memory metrics include, but are not limited to, the amount of virtual memory used, amount of idle memory, amount of memory used as buffers, amount of memory used as cache, and amount of memory swapped in from disk. Examples of disk usage metrics may include, but are not limited to, blocks received from a block device and blocks sent to a block device.

In an embodiment, monitoring service 112 may implement existing operating system features to help gather various metrics associated with virtual machines. For example, monitoring service 112 may use an operating system tool such as vmstat to help gather metrics. Vmstat is a virtual memory statistics reporting tool configured to report system information related to memory, paging, processes, I/O, and disk scheduling. In other examples, monitoring service 112 may implement other operating system tools to gather metrics related to CPU, memory, and disk usage related to database server instance 121A and database server instance 121B. Monitoring service 112, upon collecting the metrics, sends the metrics to resource allocation prediction service 113 for predicting new resource allocations for database server instance 121A and database server instance 121B.

### Resource Allocation Prediction Service

Resource allocation prediction service 113 represents a computer process or program configured to implement machine learning models for the purposes of providing resource allocation predictions. Referring to FIG. 1, server device 110 contains a CPU machine learning model (CPU ML model 114) and a memory machine learning model (memory ML model 115). In an embodiment, resource allocation prediction service 113 is implemented to provide resource allocation predictions using CPU ML model 114 and memory ML model 115. In other embodiments, resource allocation prediction service 113 may implement more or less machine learning models for providing resource allocation predictions. For instance, resource allocation prediction service 113 may implement three or more separate machine learning models for predicting CPU allocations, memory allocations, storage allocations, as well as any other resource allocation that may be configured for database server instance 121A and database server instance 121B on nodes 120A and 120B, respectively. In yet another example, resource allocation prediction service 113 may implement a single ML model, such as CPU ML model 114, for predicting an optimal CPU resource allocation for a database server instance.

Resource allocation prediction service 113 may be implemented in any number of ways, including as a stand-alone application running on server device 110, web services running on server device 110, etc. Embodiments of resource allocation prediction service 113 described herein, may be comprised of a combination of software, and allocation of resources from server device 110. Specifically, an application is a combination of integrated software components and an allocation of computational resources, such as memory, and/or processes on the computing device for executing the integrated software components on a processor, the combination of the software and computational resources being dedicated to performing the stated functions of the application.

### Machine Learning Models

Resource allocation prediction service 113 implements one or more machine learning models to provide resource allocation predictions for database instances running on nodes 120A and 120B. FIG. 1 depicts two machine learning models, CPU ML model 114 and memory ML 115. In an embodiment, CPU ML model 114 is implemented to receive, as input, an executed workload and CPU metrics collected from the executed workload on a database running on DBMS 100. CPU ML model 114 uses the observed CPU metrics to generate a resource allocation prediction, which is a prediction of an optimal number of CPU resources for the database based on the executed workload. CPU resources may refer to a number of CPUs or a number of CPU cores. For example, CPU ML model 114 may determine, from the provided CPU metrics from the executed workload, that the workload would perform optimally if the number of CPU cores allocated to database server instance 121A is increased.

In an embodiment, CPU ML model 114 is implemented to output predictions that indicate that the CPU resource should be either upsized, downsized, or should remain constant. In an embodiment, CPU ML model 114 may provide a new number of CPU resources that should be applied to database server instance 121A. For example, database server instance 121A may initially have 3 CPU cores allocated. CPU ML model 114 may receive, as input from resource allocation prediction service 113, the current cloud shape for database server instance 121A, the executed workload, and CPU metrics collected from running the workload on database server instance 121A. The current cloud shape represents the resource allocations for database server instance 121A, which include the current number of CPU cores provisioned, the current size of memory allocated to database server instance 121A, and any other relevant resource allocation information. CPU ML model 114 computes an optimal number of CPU cores, based on the input provided. If CPU ML model 114 determines that database server instance 121A needs additional CPU cores to perform optimally, then CPU ML model 114 would generate output that indicates that the CPU cores for database server instance 121A should be upsized. CPU ML model 114 may also provide a new number of CPU cores for optimal performance. For instance, the output from CPU ML model 114 may include a prediction to upsize the number of CPU cores to 4 CPU cores or 8 CPU cores for database server instance 121A. If, however, CPU ML model 114 determines that the number of CPU cores should be reduced, then the output would be a prediction to downsize the number of CPU cores. If CPU ML model 114 determines that the current number of CPU cores is correct for optimal performance, then the output would be a prediction to keep the number of CPU cores constant.

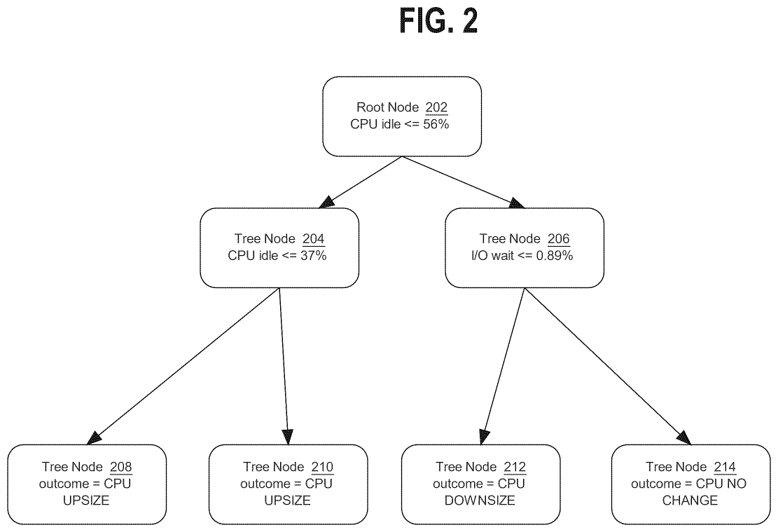

In an embodiment, CPU ML model 114 may be implemented using a decision tree. A decision tree is a hierarchical model that uses a series of questions or conditions to achieve a prediction. Decision trees or similar trees can be automatically trained and generated from the offline and online statistics collected from the database instance. The prediction outcomes are located in leaf nodes of the decision tree. When input is received the model determines a path to a leaf node (a prediction outcome), starting from the root node and traversing the tree by making a series of decisions in order to reach a specific leaf node. FIG. 2 depicts an example decision tree for predicting CPU resource changes, according to an embodiment. The decision tree depicted in FIG. 2 is just one example of a decision tree. Other examples of decision trees may have more or fewer tree nodes and may use different CPU metrics than the one depicted in FIG. 2.

Root node 202 represents the root node of the decision tree. When CPU ML model 114 receives input to make a prediction, CPU ML model 114 starts at root node 202. Root node 202 contains a condition of whether CPU idle time is less than or equal to 56%. If the inputted CPU metrics show that the CPU idle time was less than or equal to 56% then CPU ML model 114 would traverse to tree node 204. If, however, the CPU metrics show that the CPU idle time was greater than 56% then CPU ML model 114 traverses to tree node 206.

Tree node 204 contains the condition of whether the CPU idle time is less than or equal to 37%. If the CPU metrics indicate that the CPU idle time is less than or equal to 37% then CPU ML model 114 traverses to tree node 208. Tree node 208 contains the prediction outcome of CPU UPSIZE. If, however, at tree node 204 CPU ML model 114 determines that the CPU idle time is greater than 37% then CPU ML model 114 traverses to tree node 210. Tree node 210 contains the prediction outcome of CPU UPSIZE.

Returning back to tree node 206, tree node 206 contains the condition of whether the I/O wait time is less than or equal to 0.89%. If the CPU metrics indicate that the I/O wait time is less than or equal to 0.89%, then CPU ML model 114 traverses to tree node 212. Tree node 212 contains the prediction outcome of CPU DOWNSIZE. If, however, at tree node 206 CPU ML model 114 determines that the I/O wait time is greater than 0.89% then CPU ML model 114 traverses to tree node 214. Tree node 214 contains the prediction outcome of CPU NO CHANGE.

CPU ML model 114 is not limited to implementing a decision tree for predicting the optimal CPU resource allocation. In other embodiments, CPU ML model 114 may be implemented using a linear regression model, neural networks, random forest, or any other machine learning technique.

In an embodiment, memory ML model 115 is implemented to generate a resource allocation prediction for the optimal size of memory for the database based on the executed workload. Memory ML model 115 is implemented to receive, as input, the current cloud shape for a database server instance, an executed workload, and memory metrics collected from running the workload. Memory metrics may include, but are not limited to, the amount of virtual memory used, amount of idle memory, amount of memory used as buffers, amount of memory used as cache, and amount of memory swapped in from disk. Memory ML model 115 computes an optimal allocation size of memory for the database server instance, based on the input provided. Output from memory ML model 115 is a prediction that indicates whether memory resources should be either upsized, downsized, or should remain constant. For example, database server instance 121A may initially have 128 GB of memory allocated. Memory ML model 115 may receive, as input, the current cloud shape, which includes the current memory allocation size, for database server instance 121A, the executed workload, and memory metrics collected from running the workload on database server instance 121A. Memory ML model 115 computes the optimal allocation size of memory for database server instance 121A. If memory ML model 115 determines that the current memory allocation for database server instance 121A should be reduced, then memory ML model 115 would generate output that indicates that the memory allocation should be downsized. The output may additionally include an optimal memory size for database server instance 121A. For instance, the output may be, downsize memory from 128 GB to 64 GB. Similarly, if memory ML model 115 determines that the memory allocation should be increased, then the output would be upsize memory from 128 GB to 256 GB. If, however, the memory ML model determines that the current memory allocation is already optimized, then the output from memory ML model 115 would be no change and keep the memory at 128 GB.

### Training Machine Learning Models

In an embodiment, resource allocation prediction service 113 is implemented to train the machine learning models using a corpus of datasets and a corpus of cloud shapes. The corpus of datasets may contain a plurality of datasets with varying dataset properties. For instance, each of the datasets may vary based on table cardinality, the number of distinct values in each of the columns, and data placement types such as round robin. By having a wide variety of dataset shapes, the corpus of datasets provides better generalization and, in turn, results in a trained machine learning model that is able to provide predictions for any type of dataset. The corpus of cloud shapes may contain a plurality of resource configurations. For instance, the corpus of cloud shapes includes resource configurations that vary the number of CPU cores, the size of memory, and other hardware resources.

In an embodiment, database workload samples are generated for the corpus of datasets to train CPU ML model 114 and memory ML model 115. A database workload refers to a dataset being managed by a particular DBMS, and the nature and frequency of queries being run over the dataset. Database workload training samples may include varying online transaction processing (OLTP) workloads using different throughput limits, and varying transaction processing and database benchmarks. The benchmarks may be run on different system setups with varying numbers of nodes. For instance, the benchmark queries may be run on a system provisioned with a number of nodes corresponding to DBMS 100.

In another embodiment, workload samples may be automatically generated for a given dataset. For instance, thousands of workload variations may be systematically generated to create a performance prediction dataset for CPU ML model 114 and memory ML model 115. The automatically generated workloads may be a combination of both randomly generated and explicitly specified queries.

### Change Recommendation Generation Service

In an embodiment, change recommendation generation service 116 is implemented to receive resource allocation predictions from one or more ML models and generate change recommendation instructions for modifying resource allocations for one or more virtual machines connected to DBMS 100. For example, change recommendation generation service 116 may receive a resource allocation prediction from CPU ML model 114 that specifies increasing CPU cores assigned to database server instance 121A and may generate change recommendation instructions to update the number of CPU cores assigned to database server instance 121A. The change recommendation instructions may include instructions that indicate a new number of CPU cores to be allocated to database server instance 121A.

In an embodiment, change recommendation generation service 116 may consider hardware capabilities of the node that is hosting the virtual machine whose resources are to be modified, as well as any deployment constraints associated with cloud shapes for nodes that are a part of DBMS 100. The hardware capabilities of a node hosting a virtual machine whose resources are to be modified refer to the resources available on the node that may be allocated to the virtual machine. For example, CPU ML model 114 may provide a prediction to upgrade the number of CPU cores assigned to the virtual machine running database server instance 121A. Database server instance 121A currently has 12 CPU cores assigned, and node 120A currently has 4 CPU cores available for assignment, then the maximum number of additional CPU cores that change recommendation generation service 116 may provide is 4 CPU cores.

As previously described, cloud shapes represent a configuration of resources allocated to a virtual machine. For example, one cloud shape may include 8 CPU cores and 512 GB of memory, while another cloud shape may include 12 CPU cores and 1 terabyte (TB) of memory. Cloud service providers may place constraints on the number of resource configurations allowed for a cloud shape. For example, cloud service providers may only allow the following CPU core allocations: 2 CPU cores, 4 CPU cores, 8 CPU cores, 12 CPU cores, 16 CPU cores, 32 CPU cores, and so on. By having the CPU core options limited to a fixed set of configurations, change recommendation generation service 116 selects a configuration of CPU cores that is closest to the resource allocation prediction provided by CPU ML model 114. For example, if database server instance 121A currently has 8 CPU cores and CPU ML model 114 outputted a prediction that database server instance 121A should increase the current number of CPU cores, then change recommendation generation service 116 may determine and generate change recommendation instructions that indicate a new allocation of 12 CPU cores for database server instance 121A based on the fixed set of configurations. Change recommendation generation service 116 may send the change recommendation instructions to node 120A in order to apply the changes to database server instance 121A. In an embodiment, the change instructions may be a set of program instructions that may be executable on node 120A to cause the change in CPU cores allocated to database server instance 121A.

In an embodiment, change recommendation generation service 116 may be implemented to combine resource allocation predictions from two or more ML models and generate change recommendation instructions for modifying multiple resource allocations for one or more virtual machines connected to DBMS 100. For example, change recommendation generation service 116 may receive a first resource allocation prediction, from CPU ML model 114, that specifies increasing CPU cores assigned to database server instance 121A and a second resource allocation prediction, from memory ML model 115, that specifies increasing the memory allocated to database server instance 121A. Change recommendation generation service 116 may take the prediction from CPU ML model 114 and the prediction from memory ML model 115 and generate change recommendation instructions that specify increasing the number of CPU cores for database server instance 121A and the amount of memory allocated to database server instance 121A.

In some cases, change recommendation generation service 116 may receive conflicting resource allocation predictions where one prediction specifies increasing a resource allocation for one type of resource and another prediction specifies decreasing a resource allocation for another type of resource. For example, change recommendation generation service 116 may receive a first prediction from CPU ML model 114 that specifies increasing the CPU cores assigned to database server instance 121A and a second prediction from memory ML model 115 that specifies decreasing the amount of memory allocated to database server instance 121A. These predictions would be considered conflicting, as these predictions recommend different changes for their respective resource types. Change recommendation instructions that include conflicting changes to different types of resources may have a negative impact on the performance of a virtual machine. For example, if CPU ML model 114 output indicates increasing the number of CPU cores but memory ML model 115 output indicates decreasing the amount of memory allocated for database server instance 121A, the decrease in memory allocated to database server instance 121A may have a negative impact on the performance of the CPU cores assigned to database server instance 121A because the CPU cores may receive additional I/O requests if the new allocation of memory is not large enough for the new number of CPU cores allocated. Similarly, if memory ML model 115 output indicates increasing the memory allocated to database server instance 121A and CPU ML model 114 output indicates keeping the number of CPU cores the same, an increase in the memory allocation without an increase in CPU cores allocated may result in underutilization of the amount of memory allocated to database server instance 121A because database server instance 121A does not have enough CPU cores to handle additional processing throughput that would be associated with the new memory allocation.

In an embodiment, change recommendation generation service 116 may implement heuristics that apply a maximalist approach, where if one ML model predicts increasing resource allocations, then change recommendation generation service 116 will provide a similar change recommendation for the other resource allocations. For example, if CPU ML model 114 output indicates increasing CPU cores allocated to database server instance 121A and memory ML model 115 output indicates either decreasing or keeping constant the current memory allocation for database server instance 121A, then change recommendation generation service 116 may recommend increasing both the number of CPU cores and the allocation of memory for database server instance 121A. By implementing the maximalist approach for each of the resource allocations, change recommendation generation service 116 ensures that changing the allocation of one resource will not negatively impact another resource.

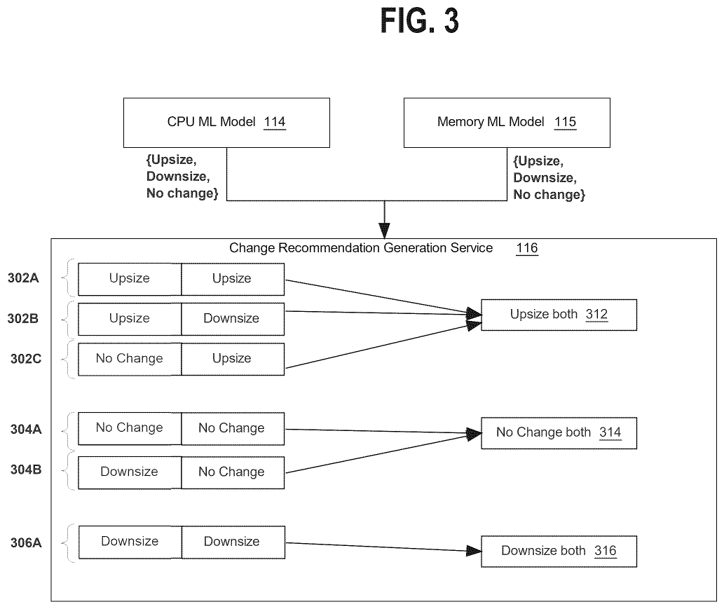

FIG. 3 is a block diagram that depicts logic for generating change recommendation instructions using resource predictions from multiple machine learning models, according to an embodiment. Change recommendation generation service 116 is depicted as receiving resource predictions from CPU ML model 114 and memory ML model 115. The resource predictions provided by CPU ML model 114 and memory ML model 115 will indicate whether the resource should be upsized, downsized, or no change should be made.

In an embodiment, when multiple ML model predictions are received, change recommendation generation service 116 applies a maximalist approach to ensure that the change recommendation instructions for the multiple resources are consistent. Referring to FIG. 3, scenario 302A represents a scenario in which change recommendation generation service 116 receives two resource predictions to upsize resources. For instance, scenario 302A would occur if CPU ML model 114 provided an upsize resource prediction and memory ML model 115 provided an upsize resource prediction. Upon receiving the two upsize resource predictions, change recommendation generation service 116 would generate change instructions to upsize both the number of CPU cores and the memory allotted to database server instance 121A, represented by box upsize both 312.

Scenario 302B represents a scenario in which change recommendation generation service 116 receives one resource prediction to upsize resources and another resource prediction to downsize resources. For example, CPU ML model 114 may provide an upsize resource prediction but memory ML model 115 provides a downsize resource prediction. Another example would be if CPU ML model 114 provides a downsize resource prediction but memory ML model 115 provides an upsize resource prediction. Upon receiving the two conflicting resource predictions, change recommendation generation service 116 would implement the maximalist approach and generate change instructions to upsize both the number of CPU cores and the memory allotted to database server instance 121A, represented by box upsize both 312.

Scenario 302C represents a scenario in which change recommendation generation service 116 receives one resource prediction for no change to resources and another resource prediction to upsize resources. For example, CPU ML model 114 may provide an upsize resource prediction but memory ML model 115 provides a prediction for no change to resources. Another example would be if CPU ML model 114 provides a prediction for no change but memory ML model 115 provides an upsize resource prediction. Upon receiving the two conflicting resource predictions, change recommendation generation service 116 implements the maximalist approach and generates change instructions to upsize both the number of CPU cores and the memory allotted to database server instance 121A, represented by box upsize both 312.

Scenario 304A represents a scenario in which change recommendation generation service 116 receives two predictions for not changing resource allocations. For instance, scenario 304A would occur if both CPU ML model 114 and memory ML model 115 provided predictions for no change to the number of CPU cores and the allotted memory. Upon receiving the two no change predictions, change recommendation generation service 116 would generate change instructions for no changes to the number of CPU cores and for no changes to the memory allotted to database server instance 121A, represented by box no change both 314. In another embodiment, if change recommendation generation service 116 determines that the change recommendation contains only “no change” recommendations for the applicable resources, then change recommendation generation service 116 may send a “no change” result without generating change instructions that include program instructions.

Scenario 304B represents a scenario in which change recommendation generation service 116 receives one resource prediction for downsizing resources and another resource prediction for no change to resources. For example, CPU ML model 114 may provide a downsize resource prediction but memory ML model 115 provides a prediction for no change to resources. Another example would be if CPU ML model 114 provides a prediction for no change but memory ML model 115 provides a downsize resource prediction. Change recommendation generation service 116 would then implement the maximal approach and generate change instructions for no changes to the number of CPU cores and for no changes to the memory allotted to database server instance 121A, represented by box no change both 314.

Scenario 306A represents a scenario in which change recommendation generation service 116 receives two resource predictions to downsize resources. For instance, scenario 306A would occur if both CPU ML model 114 and memory ML model 115 provided resource predictions to downsize the number of CPU cores and the allotted size of memory for database server instance 121A. Upon receiving the two downsize resource predictions, change recommendation generation service 116 would generate change instructions to downsize both the number of CPU cores and the memory allotted to database server instance 121A, represented by box downsize both 316.

In an embodiment, if change recommendation generation service 116 received three or more resource predictions from other ML models not depicted in FIG. 3, then change recommendation generation service 116 would still implement the maximalist approach and generate change recommendation instructions that match the highest resource prediction received. For instance, if one of the ML models provided a change recommendation to upsize resources, then the change recommendation instructions generated would recommend upsizing all resource types for which predictions were received.

### Process Overview

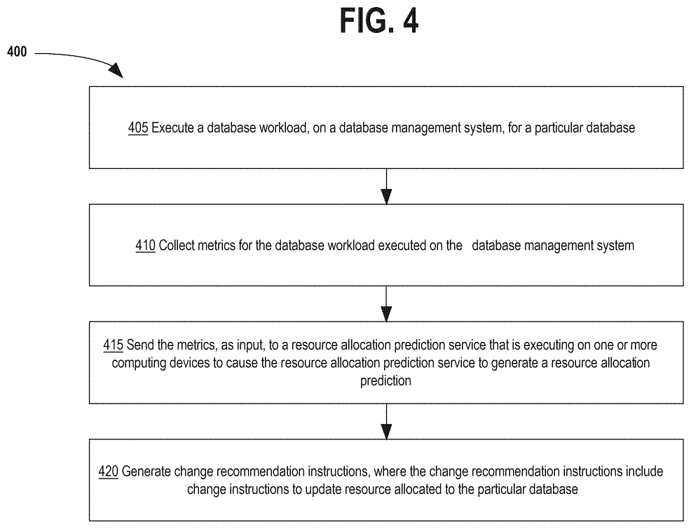

FIG. 4 depicts a flowchart for automatically generating change recommendation instructions for modifying hardware resources for one or more database servers, according to an embodiment. The steps of the process as shown in FIG. 4 may be implemented using processor-executable instructions that are stored in computer memory. For the purpose of providing a clear example, the steps of FIG. 4 are described as being performed by processes executing in DBMS 100. For the purposes of clarity, the process described may be performed with more or fewer steps than described in FIG. 4.

At step 405, process 400 executes a database workload on DBMS 100 for a particular database. In an embodiment, DBMS 100 executes a workload on database server instance 121A. The workload executed may be a historical workload of database transactions previously executed on database server instance 121A.

At step 410, process 400 collects metrics for the database workload executed on DBMS 100. In an embodiment, monitoring service 112 collects metrics for the database workload executed on database server instance 121A. The metrics may include CPU metrics such as CPU idle time, CPU wait time for input/output, number of processes waiting for runtime, number of processes in uninterruptible sleep, number of interrupts per second, number of context switches per second, time spent running non-kernel code, time spent running kernel code, and time stolen from a virtual machine.

In an embodiment where resource allocation prediction service 113 implements both CPU ML model 114 and memory ML model 115, monitoring service 112 collects CPU metrics and memory metrics for the executed database workload. The memory metrics may include an amount of virtual memory used, amount of idle memory, amount of memory used as buffers, amount of memory used as cache, and amount of memory swapped in from disk. In yet other embodiments where resource allocation prediction service 113 implements additional resource ML models not depicted in FIG. 1, monitoring service 112 would collect resource metrics that are specific to the implemented ML models.

At step 415, process 400 sends the metrics, as input, to the resource allocation prediction service that is executing on one or more computing devices to cause the resource allocation prediction service to generate a resource allocation prediction. In an embodiment, monitoring service 112 sends the collected metrics to resource allocation prediction service 113. If resource allocation prediction service 113 has implemented a single ML model, such as CPU ML model 114, then resource allocation prediction service 113 may send a request to CPU ML model 114 to generate a resource allocation prediction for an optimal number of CPU cores for database server instance 121A. The input for CPU ML model 114 may include the collected CPU metrics, the executed workload, and the current cloud shape for database server instance 121A. The output from CPU ML model 114 is a recommendation to either upsize, downsize, or keep constant the current number of CPU cores allocated to database server instance 121A. Additionally, the output may include an optimal number of CPU cores for database server instance 121A.

In another embodiment where resource allocation prediction service 113 has implemented both CPU ML model 114 and memory ML model 115, resource allocation prediction service 113 would send requests to CPU ML model 114 and memory ML model 115 to generate resource allocation predictions for an optimal number of CPU cores and the optimal memory allocation size for database server instance 121A, respectively. The input for CPU ML model 114 would be the same as described in the previous example. The input for memory ML model 115 may include the collected memory metrics, the executed workload, and the current cloud shape for database server instance 121A. The output from memory ML model 115 may include a recommendation to either upsize, downsize, or keep constant the current amount of memory size provisioned to database server instance 121A, as well as an optimal prediction of the needed memory size for database server instance 121A. Output predictions from CPU ML model 114 and memory ML model 115 are sent to change recommendation generation service 116.

At step 420, process 400 generates change recommendation instructions based on the resource allocation prediction, where the change recommendation instructions include change instructions to update resources allocated to the particular database in order to align current resources allocated to the particular database with the resource allocation prediction. In an embodiment, change recommendation generation service 116 generates change recommendation instructions based on the resource allocation predictions received from CPU ML model 114, memory ML model 115, or both. The change recommendation instructions may include change instructions in the form of program instructions to be executed on the node hosting the target database server instance, such as node 120A for database server instance 121A.

In an embodiment where both CPU ML model 114 and memory ML model 115 have been implemented, change recommendation generation service 116 determines whether the output predictions from CPU ML model 114 and memory ML model 115 are conflicting, such as one output prediction recommends upsizing a resource while the other output prediction recommends either downsizing or keeping the other resource the same. If change recommendation generation service 116 determines that the output predictions are conflicting, then change recommendation generation service 116 may implement heuristics to apply a maximalist approach for updating multiple resource allocations for a database server instance. For example, referring to FIG. 3, scenario 302B, CPU ML model 114 provides an upsize resource prediction but memory ML model 115 provides a downsize resource prediction. Change recommendation generation service 116 would implement the maximalist approach and generate change instructions to upsize both the number of CPU cores and the memory allotted to database server instance 121A.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria are met.

In a software implementation, when a machine learning model is referred to as receiving an input, being executed, and/or generating an output or prediction, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of the best breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N [L−1] and N [L], respectively, the dimensions of matrix W is N [L−1] columns and N [L] rows.

Biases for a particular layer L may also be stored in matrix B having one column with N [L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as a sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Fewer neurons means fewer activation values need be computed, and/or fewer derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in a matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that are not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depend on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occur as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

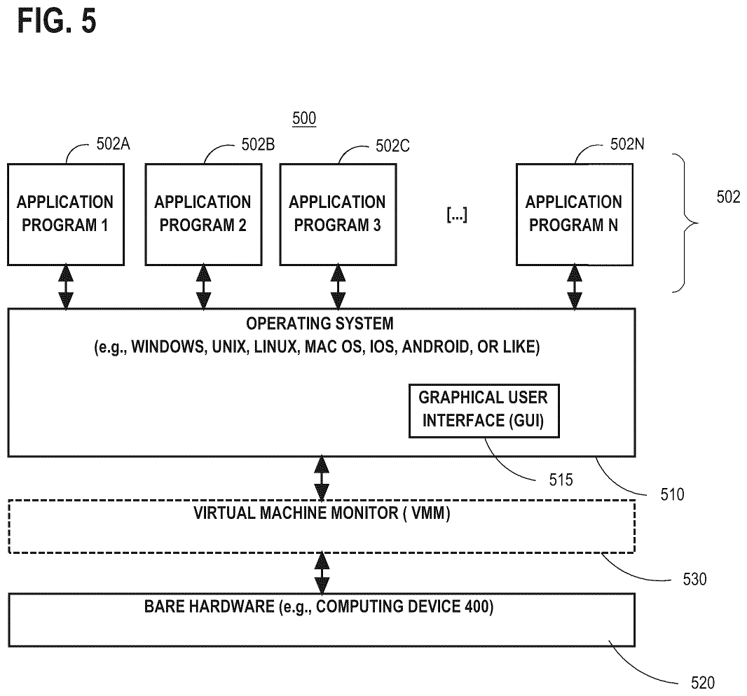

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Over View

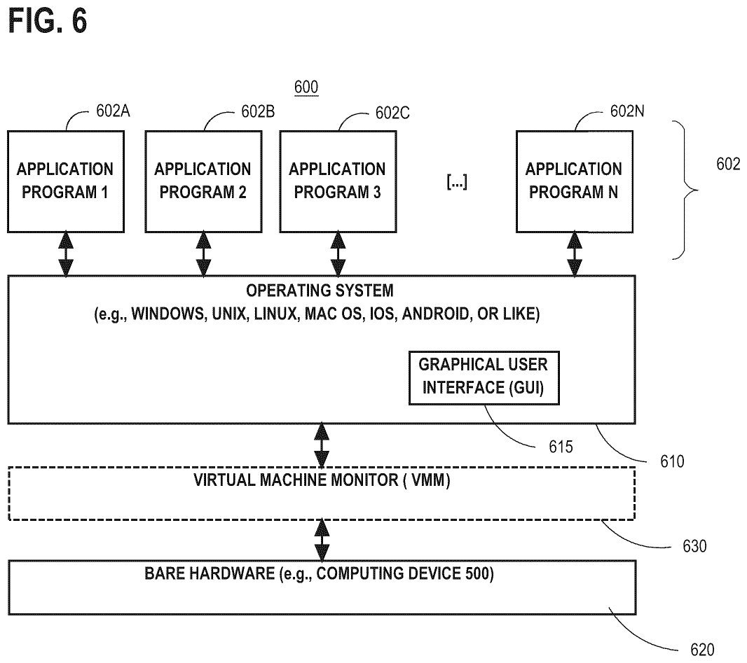

FIG. 6 is a block diagram of a basic software system 600 that may be employed for controlling the operation of computer system 600. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the runtime execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DbaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
executing a database workload, on a database management system, for a particular database, wherein the database management system is hosted on one or more virtual machines;
collecting, by a monitoring service, metrics for the database workload executed on the database management system;
wherein the metrics include CPU metrics for one or more CPUs allocated to the particular database;
sending the metrics, as input, to a resource allocation prediction service that is executing on one or more computing devices to cause the resource allocation prediction service to generate a resource allocation prediction;
wherein the resource allocation prediction service comprises a CPU-resource machine learning model designated to predict an optimal number of CPU resources for the particular database based on the metrics;
wherein the resource allocation prediction includes at least a recommended number of CPUs to be assigned to the particular database;
generating, by a change recommendation generation service, change recommendation instructions based on the resource allocation prediction, wherein the change recommendation instructions include change instructions to update resources allocated to the particular database in order to align current resources allocated to the particular database with the resource allocation prediction.

2. The computer-implemented method of claim 1, wherein the change recommendation instructions are limited to updating a discrete set of plans, each plan containing a particular allocation of two or more resources.

3. The computer-implemented method of claim 1, wherein the resource allocation prediction service further comprises a memory-resource machine learning model designated to predict an optimal size of memory resources for the particular database based on the metrics.

4. The computer-implemented method of claim 3, wherein the resource allocation prediction further includes a recommended size of memory resources to be assigned to the particular database; and
wherein the change recommendation instructions include change instructions to update a number of CPUs assigned to the particular database and a size of memory resources assigned to the particular database.

5. The computer-implemented method of claim 4, wherein generating the change recommendation instructions based on the resource allocation prediction comprises:
determining that the resource allocation prediction contains a first recommendation to upsize the number of CPUs and a second recommendation to downsize memory resources; and
generating the change recommendation instructions to include the change instructions to update the resources allocated to the particular database such that the number of CPUs is increased and the size of memory resources is increased.

6. The computer-implemented method of claim 4, wherein generating the change recommendation instructions based on the resource allocation prediction comprises:
determining that the resource allocation prediction contains a first recommendation for no changes to the number of CPUs and a second recommendation to downsize memory resources;
generating the change recommendation instructions to include the change instructions to update the resources allocated to the particular database such that the number of CPUs remains constant and the size of memory resources remains constant.

7. The computer-implemented method of claim 4, wherein generating the change recommendation instructions based on the resource allocation prediction comprises:
determining that the resource allocation prediction contains two recommendations for updating the number of CPUs and the memory resources respectively, where the two recommendation both recommend either upsizing resources, downsizing resources, or keeping resources constant;
generating the change recommendation instructions to include the change instructions to update the resources allocated to the particular database such that the number of CPUs and the size of memory resources are both either increased, decreased, or kept constant.

8. The computer-implemented method of claim 1, wherein the CPU-resource machine learning model implements a decision tree.

9. The computer-implemented method of claim 1, further comprising training the CPU-resource machine learning model using a training corpus with data representing a plurality of different database workloads including a plurality of different workload-specific features, a plurality of different dataset-specific features, a plurality of different database schemas, a plurality of resource shapes, and a plurality of performance metrics associated with the plurality of different database workloads.

10. The computer-implemented method of claim 1, wherein the CPU metrics include at least one of:
CPU idle time,
CPU wait time for input/output,
a number of processes waiting for runtime,
a number of processes in uninterruptible sleep,
an amount of virtual memory used,
an amount of idle memory,
an amount of memory used as buffers,
an amount of memory used as cache,
an amount of memory swapped in from disk,
an amount of memory swapped to the disk,
a first set of blocks received from a block device,
a second set of blocks sent to the block device,
number of interrupts per second,
number of context switches per second,
time spent running non-kernel code,
time spent running kernel code, and
time stolen from a specific virtual machine.

11. One or more non-transitory computer-readable media storing instructions which, when executed by one or more processors, cause:
executing a database workload, on a database management system, for a particular database, wherein the database management system is hosted on one or more virtual machines;
collecting, by a monitoring service, metrics for the database workload executed on the database management system;
wherein the metrics include CPU metrics for one or more CPUs allocated to the particular database;
sending the metrics, as input, to a resource allocation prediction service that is executing on one or more computing devices to cause the resource allocation prediction service to generate a resource allocation prediction;
wherein the resource allocation prediction service comprises a CPU-resource machine learning model designated to predict an optimal number of CPU resources for the particular database based on the metrics;
wherein the resource allocation prediction includes at least a recommended number of CPUs to be assigned to the particular database;
generating, by a change recommendation generation service, change recommendation instructions based on the resource allocation prediction, wherein the change recommendation instructions include change instructions to update resources allocated to the particular database in order to align current resources allocated to the particular database with the resource allocation prediction.

12. The one or more non-transitory computer-readable media of claim 11, wherein the change recommendation instructions are limited to updating a discrete set of plans, each plan containing a particular allocation of two or more resources.

13. The one or more non-transitory computer-readable media of claim 11, wherein the resource allocation prediction service further comprises a memory-resource machine learning model designated to predict an optimal size of memory resources for the particular database based on the metrics.

14. The one or more non-transitory computer-readable media of claim 13, wherein the resource allocation prediction further includes a recommended size of memory resources to be assigned to the particular database; and
wherein the change recommendation instructions include change instructions to update a number of CPUs assigned to the particular database and a size of memory resources assigned to the particular database.

15. The one or more non-transitory computer-readable media of claim 14, wherein generating the change recommendation instructions based on the resource allocation prediction comprises:
determining that the resource allocation prediction contains a first recommendation to upsize the number of CPUs and a second recommendation to downsize memory resources; and
generating the change recommendation instructions to include the change instructions to update the resources allocated to the particular database such that the number of CPUs is increased and the size of memory resources is increased.

16. The one or more non-transitory computer-readable media of claim 14, wherein generating the change recommendation instructions based on the resource allocation prediction comprises:
determining that the resource allocation prediction contains a first recommendation for no changes to the number of CPUs and a second recommendation to downsize memory resources;
generating the change recommendation instructions to include the change instructions to update the resources allocated to the particular database such that the number of CPUs remains constant and the size of memory resources remains constant.

17. The one or more non-transitory computer-readable media of claim 14, wherein generating the change recommendation instructions based on the resource allocation prediction comprises:
determining that the resource allocation prediction contains two recommendations for updating the number of CPUs and the memory resources respectively, where the two recommendations both recommend either upsizing resources, downsizing resources, or keeping resources constant;
generating the change recommendation instructions to include the change instructions to update the resources allocated to the particular database such that the number of CPUs and the size of memory resources are both either increased, decreased, or kept constant.

18. The one or more non-transitory computer-readable media of claim 11, wherein the CPU-resource machine learning model implements a decision tree.

19. The one or more non-transitory computer-readable media of claim 11, storing additional instructions which, when executed by the one or more processors, further cause:
training the CPU-resource machine learning model using a training corpus with data representing a plurality of different database workloads including a plurality of different workload-specific features, a plurality of different dataset-specific features, a plurality of different database schemas, a plurality of resource shapes, and a plurality of performance metrics associated with the plurality of different database workloads.

20. The one or more non-transitory computer-readable media of claim 11, wherein the CPU metrics include at least one of:
CPU idle time,
CPU wait time for input/output,
a number of processes waiting for runtime,
a number of processes in uninterruptible sleep,
an amount of virtual memory used,
an amount of idle memory,
an amount of memory used as buffers,
an amount of memory used as cache,
an amount of memory swapped in from disk,
an amount of memory swapped to the disk,
a first set of blocks received from a block device,
a second set of blocks sent to the block device,
number of interrupts per second,
number of context switches per second,
time spent running non-kernel code,
time spent running kernel code, and
time stolen from a specific virtual machine.
